(19) United States
(12) Patent Application Publication
(10) Pub. No.: US 2021/0378907 A1
(43) Pub. Date: Dec. 9, 2021

(54) Thigh-Only Deep Vein Thrombosis Device and Double Pulsation Method of Using Device

(71) Applicant: Arjo IP Holding Aktiebolag, Malmo (SE)

(72) Inventors: Michael David Newton, Boerne, TX (US); Rhys John Morris, Cardiff (GB); Lisa Maria Paige, San Antonio, TX (US)

(21) Appl. No.: 17/286,047

(22) PCT Filed: Oct. 9, 2019
(86) PCT No.: PCT/SE2019/050990

§ 371 Date: Apr. 16, 2021

Related U.S. Application Data
(60) Provisional application No. 62/747,864, filed on Oct. 19, 2018.

(30) Foreign Application Priority Data
Feb. 5, 2019 (SE) 1950136-0

(51) Int. Cl. A61H 9/00

(52) U.S. Cl. CPC A61H 9/0092; A61H 2209/00; A61H 2205/108; A61H 2201/50; A61H 2201/0103

(57) ABSTRACT

A device for applying compression to a patient's limb includes a sleeve and a control unit configured to supply pressurized fluid to the sleeve using the following inflation/deflation process: inflating the at least one chamber from an initial pressure to a first pressure; maintaining the at least one chamber at the first pressure for a first predetermined amount of time; changing the pressure in the at least one chamber from the first pressure to a second pressure, wherein the second pressure is greater than the initial pressure; maintaining the at least one chamber at the second pressure for a second predetermined amount of time; changing the pressure in the at least one chamber from the second pressure to the first pressure or a third pressure greater than the second pressure; maintaining the at least one chamber at the first pressure or the third pressure for a third predetermined amount of time; and deflating the at least one chamber to zero pressure or a fourth pressure.

### BACKGROUND OF THE INVENTION

### Field of the Invention

The present disclosure relates, generally, to a compression apparatus and method to apply compression to a patient's limb using such device and, in particular, to a thigh-only Deep Vein Thrombosis prophylaxis device and a double pulsation method of applying compression to a patient's limb.

### Description of Related Art

In order for tissues to remain healthy, blood flow and lymph flow have to be optimal in a patient's limb. In a healthy human, effective flow of these fluids is controlled by the interaction of many homeostatic systems. Prolonged interruption of appropriate flow in any of the fluid transport vessels can result in deterioration range of adverse clinical effects. The drainage or return flow is as crucial as the supply flow in maintaining tissue health. In vascular disease, appropriately augmented blood flow to and from the affected tissues will improve the health of the tissue and promote rapid healing where tissue damage has been sustained.

In the study of thrombosis, there are well known clinical concepts known as Virchow's Triad and its modern equivalent triad. The triads consist of three separate hemodynamic aspects that are postulated to interact and contribute to the formation of a venous blood clot (thrombus) in the limbs. These aspects are typically identified as three causal factors—stasis, hypercoagulability and venous injury. Venous injury is a potential underlying cause and typically not able to be positively affected by a specific prophylaxis method. However, it is possible to provide a prophylaxis to prevent the effects of the other potential causal factors—venous stasis and hypercoagulability. The use of intermittent compression is particularly beneficial in this respect.

To minimize or prevent the occurrence of thrombosis due to these factors, there are a number of different prophylactic approaches available within current clinical practice, each approach having varying levels of clinical suitability, applicability and levels of effectiveness. The use of pharmacological agents to prevent venous thromboembolism (VIE) is targeted at the hypercoagulability aspect of the triad and, although in widespread clinical use, has a number of limitations in terms of contraindications and side effects to the patient, such as increased internal bleeding. However, the resulting reduction in the ability of the blood to coagulate can also form a negative effect in that it can result in both an increase in the complexity and duration of surgical procedures.

The use of simpler compression methods, such as compression stockings, may also be used to prevent stasis by increasing venous blood flow velocity by providing a constant low pressure to the limb. This is thought to be achieved by reducing vein diameter by means of the compression which reduces vein distension. However, current evidence suggests that these devices do not affect the blood hypercoagulability or increase in blood flow to the same extent as intermittent pneumatic compression. Compression hosiery that is configured as a stocking to be worn on a patient's limb is often available in a calf-size or a size encompassing both the calf and thigh. This hosiery is intended to provide a static compression force that could increase the venous return flow.

Use of a mechanical compression device, however, is often used in conjunction or in place of pharmacological-based prophylaxis or compression hosiery. Various conventional compression devices have been known in the art for applying compressive pressure to a patient's limb(s) in order to improve blood flow. For example, it is known to use intermittent pneumatic compression systems for Deep Vein Thrombosis (DVT) prophylaxis applied to a patient's lower limb before, during, and after surgery. These systems are used to promote increased flow within the leg veins, preventing blood stasis and the risk of subsequent formation of thromboii. All parts of the vascular system of a patient's limb are linked in terms of the flow of venous blood. Therefore, compression of any specific part of a patient's limb will have at least some effect in all other parts of the patient's limb and wider body. For example, when a patient's calf is compressed using a traditional calf garment, the blood in the thigh does not remain static. The blood ejected from the calf travels into the thigh and displaces blood from the thigh. For patients with healthy veins, the blood cannot move distally (away from the direction of the heart) due to the valves present in the veins. Even in patients with incompetent valves (i.e., valves that do not close fully and, hence, do not prevent retrograde flow), the blood from the calf cannot all be stored in the foot. Therefore, it is inherently the case that calf compression will reduce stasis in the thigh. Similarly, foot compression will also affect the flow in the calf and thigh, albeit to a lesser extent than direct compression of the calf and/or thigh. More complex compression systems using a multi-chamber inflatable garment covering a patient's entire lower limb are available for treatment of lymphedeina. The chambers are inflated and deflated in a sequential pattern to force the excess interstitial fluid in an upward direction. Intermittent compression is also used to promote healing of obstinate venous and arterial wounds. All of these techniques are applied with a variety of compression cycle times and pressures.

Many lower limb compression devices known in the art are configured for use on a patient's foot, calf, hand/arm or a combination of the calf and thigh. Many conventional compression devices for a combination of the calf and thigh are often referred to as “thigh high”. These products combine compression on the patient's calf and also include an inflatable chamber on the patient's thigh. The inflatable chamber(s) on the calf are connected to the inflatable chamber(s) on the thigh. The calf garment section typically pneumatically feeds the thigh section with pressurized fluid. It is not possible to only inflate the thigh section without also first inflating the calf section. The two sections of the inflatable chamber of the compression device are aligned behind the patient's leg as this is where the calf section should be fitted. Therefore, in this arrangement, the rear portion of the patient's thigh is compressed. Other examples exist of calf and thigh garments with independent feed paths but where the calf section is inflated prior to the inflation of the thigh section and operate in a similar manner and intended effect. In all of the above “thigh high” examples, the calf is always compressed.

Whilst intended to move fluid in a patient's calf and thigh, there are a variety of situations in which the use of a calf-thigh combination compression device is not feasible or effective. There are many locational-based circumstances where calf compression is not applicable or needed, such as a calf wounds, calf fractures, calf fixators, calf casts, calf dressings, calf skin conditions, and/or amputations, among others. Therefore, due to these circumstances, the placement of a compression device on the patient's calf truly cause additional damage, cause discomfort, or prevent healing of the patient's calf, such that the use of a calf-thigh combination compression device is not desired.

While it is possible to use foot-based compression in some situations in which calf-based compression is not feasible, there are often several disadvantages to foot-based compression. In particular, foot-based compression uses a higher compression pressure, is less comfortable, is more expensive, moves less blood through the patient's limb, and prevents mobilization. Further, the act of walking with a foot-based compression device is often contraindicated as it interferes with the operation of the portable compression pump on the compression device and can also be hazardous to the patient due to the risk of tripping over the air hoses in proximity to the foot garment.

Intermittent Pneumatic Compression (IPC) systems are widely used to assist with the circulation of fluid within the patient's body and have benefits and application for arterial, venous, and lymphatic systems. An important application of an IPC system is in the prevention of DVT or VTE. In the use of an IPC system as a means of preventing DVT/VTE in a patient's limb, the limb of the patient (e.g., calf or combination of calf and thigh) is normally compressed by means of a pressurized fluid provided to an inflatable garment wrapped around the limb. As shown in FIG. 7, the compression is applied over a period of typically 12 seconds, followed by an extended period with little or no compression lasting an additional period of typically 48 seconds. The garment is then repeatedly inflated with this inflation sequence to provide a continual prophylaxis to the patient's limb, which results in an increase in the blood flow from the limb.

During the inflated time of typically 12 seconds, the venous blood is moved proximally in the limb in order to reduce venous stasis and provide further and additional beneficial effects in terms of augmenting the naturally-produced anti-coagulants within the blood through the compression of the vein walls. There is also an associated improvement in the arterial flow into the limb. The majority of the augmentation in the velocity of the blood flow is achieved in the first part of the 12 second compression duration (typically in the first 3-7 seconds dependent on the type of the inflatable garment/sleeve attached and the nature of the inflation). The remainder of the compression time helps to ensure that a positive pressure is maintained to ensure that the blood continues to move through the patient's limb. It is the known standard of operation within the prior art that the target pressure (e.g. 40 mmHg or 45 mmHg) is applied and maintained continuously at this level during the remainder of the inflation period. IPC systems that have multiple sequential inflation chambers use the remainder of the compression time to inflate the more proximal chambers.

Current intermittent compression systems aim to address two aspects of Virchow's triad. These aspects are the prevention of stasis by promotion of an increase in venous blood flow, and to address hypercoagulability through alterations in the constitution of the blood as a result of the vein compression mechanism. In addition, a further key consideration is the location within the vein where a DVT or clot can form. It has long been postulated in clinical literature that this can occur behind the venous valve cusps, where the blood flow is less even if venous stasis is overcome. This position provides a degree of shelter from the main venous flow within the vein and, therefore, results in a region where slower flow or static blood can be found. The disturbed blood flow achieved by the initial part of the compression pulse provides a turbulent flow effect resulting in a flushing mechanism around and behind the valve cusps in the vein, which also helps to augment the reduction in venous stasis and prevent larger thrombus formation. This is often cited as an advantage of the intermittent compression-based prophylaxis compared to pharmacological-based prophylaxis and static compression stockings.

As shown in FIG. 7, depicting a typical compression method used in prior art garments, the applied pressure is in the range 25-65 mmHg for use on a calf garment and is effective throughout this pressure range. The inflation portion of the compression pulse cycle typically occurs over the initial period of approximately 3-7 seconds depending on the garment type, size and capability of the air source. Once the target pressure is achieved, the pressure typically remains at a constant level for the remainder of the inflated portion of the method. The inflatable chamber of the calf garment is then deflated to a zero pressure. This cycle is continuously repeated on the patient's limb to provide a well-established method of DVT prophylaxis.

FIG. 8 illustrates an ultrasound scan image of the compression method used in prior art garments. The scan image shows the effect of the compression method on the femoral blood velocity (y axis) against time (x axis) over a 13 second scan period. The scan image has only one blood velocity peak, shown at the −11 second marker. This velocity peak corresponds with the single compression pulse. After this single pulse is applied and the resulting blood velocity increase is achieved, there is little additional blood flow for the rest of the period of inflation despite pressure being constantly applied.

### SUMMARY OF THE INVENTION

In view of the foregoing, a need exists for a thigh-only DVT compression garment to apply compressive forces only to a patient's thigh. Another need exists for a double pulsation compression method to be used with any type of compression garment (such as a single chamber or multi-chamber, uniform or sequential) to reduce DVT/VTE in a patient's limb.

In accordance with one aspect of the disclosure, a device for applying compression to a limb of a patient includes a sleeve configured to be positioned on the patient's limb, the sleeve including an internal sleeve passage configured to receive the patient's limb, and at least one inflatable chamber, and a control unit configured to supply pressurized fluid to the at least one inflatable chamber using the following inflation/deflation process: inflating the at least one chamber from an initial pressure to a first pressure; maintaining the at least one chamber at the first pressure for a first predetermined amount of time; changing the pressure in the at least one chamber from the first pressure to a second pressure, wherein the second pressure is greater than the initial pressure; maintaining the at least one chamber at the second pressure for a second predetermined amount of time; changing the pressure in the at least one chamber from the second pressure to the first pressure or a third pressure greater than the second pressure; maintaining the at least one chamber at the first pressure or the third pressure for a third predetermined amount of time; and deflating the at least one chamber to zero pressure or a fourth pressure.

In accordance with another aspect of the disclosure, changing the pressure in the at least one chamber from the first pressure to the second pressure includes partially deflating the at least one chamber. Changing the pressure in the at least one chamber from the second pressure to the first pressure or the third pressure includes inflating the at least one chamber. The initial pressure is equal to the zero pressure or the fourth pressure. The initial pressure is different from the zero pressure or the fourth pressure. The sleeve is configured for use only on the patient's thigh. The first pressure is typically between 40 mmHg and 45 mmHg. However, it is also contemplated that the first pressure is between 25 mmHg and 65 mmHg. The second pressure is greater than zero and less than 45 mmHg. The second predetermined amount of time is at least two seconds. The duration of the entire inflation/deflation process is less than 15 seconds. The inflation/deflation process is repeatable with a duration of time in-between each cycle of the inflation/deflation process lasts greater than 28 seconds. The control unit may be configured to detect a sensible and measureable identification component located in a garment connector, wherein a specific identification detected by the control unit is a thigh-only garment identification. The control unit is, therefore, configurable for use with the thigh-only garment through the measured component.

In another aspect of the disclosure, a method of supplying pressurized fluid to at least one inflatable chamber of a compression garment includes: inflating the at least one chamber from an initial pressure to a first pressure; maintaining the at least one chamber at the first pressure for a first predetermined amount of time; changing the pressure in the at least one chamber from the first pressure to a second pressure, wherein the second pressure is greater than the initial pressure; maintaining the at least one chamber at the second pressure for a second predetermined amount of time; changing the pressure in the at least one chamber from the second pressure to the first pressure or a third pressure greater than the second pressure; maintaining the at least one chamber at the first pressure or the third pressure for a third predetermined amount of time; and deflating the at least one chamber to zero pressure or a fourth pressure.

In another aspect of the disclosure, changing the pressure in the at least one chamber from the first pressure to the second pressure includes deflating the at least one chamber. Changing the pressure in the at least one chamber from the second pressure to the first pressure or the third pressure includes inflating the at least one chamber. The initial pressure is equal to the zero pressure or the fourth pressure. The initial pressure is different from the zero pressure or the fourth pressure. The sleeve is configured for use only on the patient's thigh. The first pressure is typically between 40 mmHg and 45 mmHg. However, it is also contemplated that the first pressure may be between 25 mmHg and 65 mmHg. The second pressure is greater than zero and less than 45 mmHg. The second predetermined amount of time is at least two seconds. A duration of the entire inflation/deflation process is less than 15 seconds. The inflation/deflation process is repeatable with a duration of time in-between each cycle of the inflation/deflation process which lasts greater than 28 seconds.

In other aspects of the disclosure, a compression garment wherein an entirety of the garment surrounds a thigh of a patient, the compression garment applying compression only to the thigh of the patient consists of an outer sleeve configured to only be positioned on the patient's thigh and at least one inflatable chamber provided in the outer sleeve to apply a compressive force solely to the patient's thigh. A recess is defined in a proximal edge of the garment. The at least one inflatable chamber may include a first inflatable section offset from a second inflatable section. The at least one inflatable chamber may include three inflatable chambers. When the garment is positioned on the patient's thigh, the at least one inflatable chamber is configured to apply the compressive force to an inner surface of the patient's thigh. The garment may include an identification component, capable of being sensed and/or measured, to allow the control unit to automatically identify a garment type as being of a specific type. The garment with at least one inflatable chamber may be configured to be located on a patient's thigh and may be configured to be pressurized to greater than 24 mmHg and less than 66 mmHg. 31. A sequential compressive force may be applied solely to the thigh region of a human body. The compression force may be directly applied to the anterior region of the thigh. The compression force may be applied on the inner and front face of the thigh. At least one chamber in the compression garment may be located on the anterior region of the thigh. At least one chamber in the compression garment may be located on the inner and front face of the thigh. The chambers may be located within the garment to apply compression on the anterior of the thigh of either leg. The compression effect provided by the garment and inflatable chamber may be the same when fitted to either limb and hence the garment can be used bilaterally. The compression effect provided by the garment and inflatable chamber may be different when fitted to left and right limbs. The garments may be marked with either a left or right limb indication. The limb indication may be screen printed onto the garment. The device may be individually packaged and provided to the point of use as a singular compression garment. The device may be packaged in a multiple of at least two compression garments and provided to the point of use. The device may be intended for single-patient use. The device may be intended for use on multiple patients.

In another aspect of the present disclosure, a method of reprocessing a device such as the device recited above, comprises a step of cleaning the device between subsequent uses by differing patients. The cleaning method may involve high-level disinfection. The cleaning method may involve the use of ethylene oxide gas. The connector may be changed during the cleaning process. The inflatable chambers may be inflated as part of the cleaning process.

Further details and advantages will be understood from the following detailed description read in conjunction with the accompanying drawings.

### BRIEF DESCRIPTION OF THE DRAWINGS

FIG. 1 is a front view of a patient's lower limb with a compression garment according to the present disclosure applied only to the patient's thigh;

FIG. 2 is a top view of a compression garment according to one aspect of the present disclosure;

FIG. 3 is a top view of a compression garment according to another aspect of the present disclosure;

FIG. 4 is a top view of a compression garment according to another aspect of the present disclosure;

FIG. 5 is a top view of a compression garment according to another aspect of the present disclosure;

FIG. 6 is a top view of a compression garment according to another aspect of the present disclosure;

FIG. 7 is a waveform graph showing a compression waveform according to the prior art for use with a compression garment;

FIG. 8 is a Doppler ultrasound scan image showing the use of a compression waveform according to the prior art on a human's calf;

FIG. 9 is a waveform graph showing a compression waveform according to an aspect of the present disclosure for use with a compression garment; and

FIG. 10 is a Doppler ultrasound scan image showing the use of a compression waveform according to the present disclosure on a human's calf.

### DESCRIPTION OF THE DISCLOSURE

For purposes of the description hereinafter, spatial orientation terms, as used, shall relate to the referenced embodiment as it is oriented in the accompanying drawings, figures, or otherwise described in the following detailed description. However, it is to be understood that the embodiments described hereinafter may assume many alternative variations and configurations. It is also to be understood that the specific components, devices, features, and operational sequences illustrated in the accompanying drawings, figures, or otherwise described herein are simply exemplary and should not be considered as limiting.

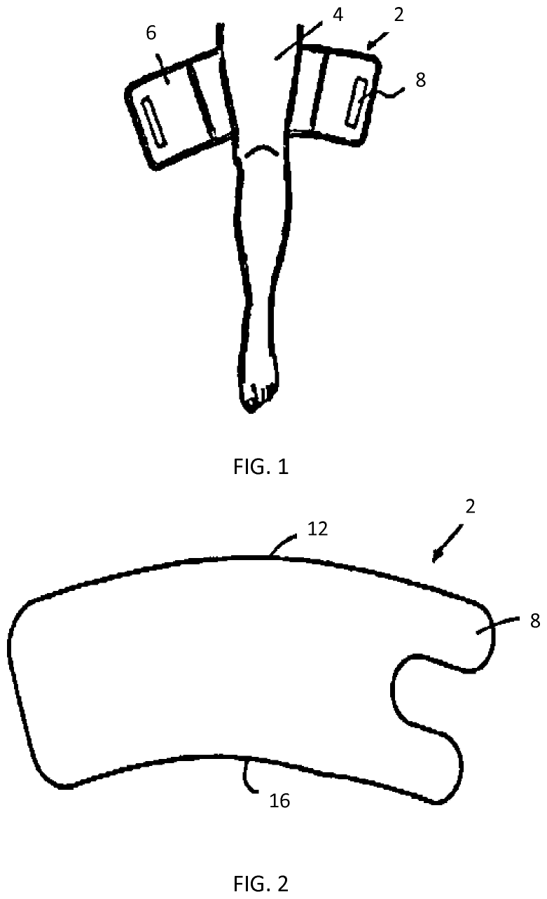

The present disclosure is directed to, in general, a DVT compression garment and a method to apply compression to a patient's limb using the garment and, in particular, to a thigh-only Deep Vein Thrombosis compression garment and a double pulsation method of applying compression to a patient's limb. Certain preferred and non-limiting aspects of the garment and method of compression are illustrated in FIGS. 1-6, 9, and 10.

### I. Thigh-Only DVT Garment

With reference to FIGS. 1-6, a DVT compression garment 2 (hereinafter referred to as “garment 2”) is shown and described. In one aspect, the garment 2 is configured for placement about only one portion of a patient, such as only on a patient's thigh 4. The garment 2 does not include additional portions or segments for attachment to a second portion of a patient, such as a patient's calf, waist, foot, knee or any other limb. In one aspect shown in FIG. 2, the garment 2 is a single garment configured to be wrapped around the patient's thigh 4. In another aspect shown in FIG. 1, the garment 2 includes a plurality of sections 6 connected together to wrap around the patient's thigh 4. The garment 2 may be made of a brushed loop polyester laminated to a foam base with at least one inflatable chamber 14. The garment 2 may be made to include Lyrcra, Spandex, and/or Elastane, as well as the materials typically found in the prior art such as fabrics, foams, and spacer materials. At least a portion of the garment 2 may include an elastic material to allow the garment to flex and expand to better accommodate different sizes of patients' thighs 4. The garment 2 may be configured for attachment about the patient's thigh between the patient's knee and genital area. Either or both ends of the garment 2 may include fasteners 8 used to connect the ends of the garment 2 together for securement of the garment 2 about the patient's thigh 4. The fasteners 8 may be buttons, hook-and-loop fasteners, such as Velcro, hooks, zippers, adhesive tapes, or any other releasable mechanical fastener suitable to connect the two ends of the garment 2 to one another.

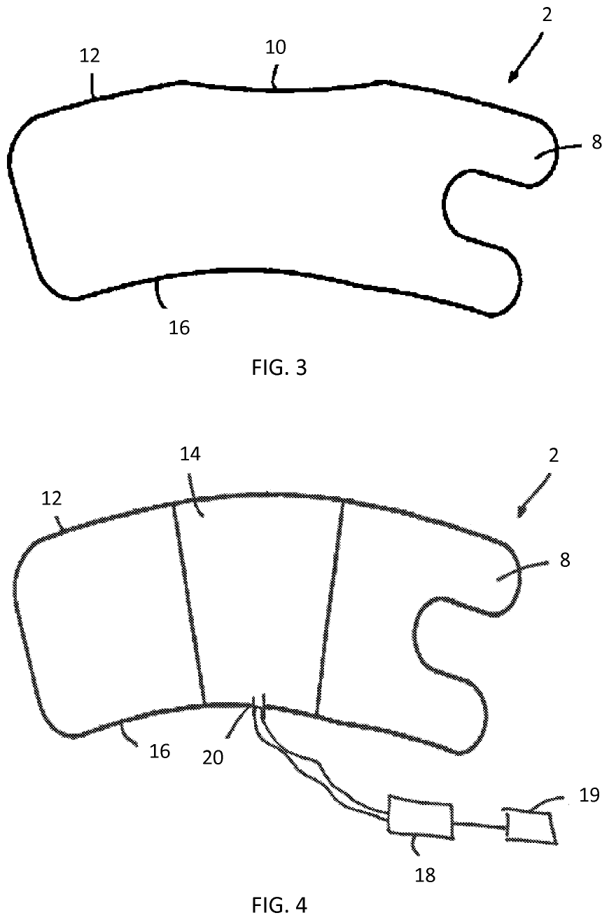

As shown in FIGS. 2 and 3, the garment 2 has an overall rectangular shape. It is also contemplated that alternative shapes may be used to ensure secure attachment of the garment 2 to the patient's thigh 4. As shown in FIG. 3, in one aspect of the garment 2, a concave recess 10 is defined in an upper or proximal edge 12 of the garment 2. By providing the recess 10 in the garment 2, a larger separation of the proximal edge 12 of the garment 2 and the patient's genital area is achieved. In conventional garments that include a combination of calf and thigh sections, the thigh section is often positioned in close proximity to the patient's genital area, which can cause irritation, discomfort, and potential injury when using the garment. The recess 10 of the garment 2 of the present disclosure ensures that the garment 2 does not irritate, interfere with, or injury a patient's genital area, since the proximal edge 12 of the garment 2 is substantially spaced from the patient's genital area as a result of the recess 10. The recess 10 ensures that there is more tolerance with the garment 2 to avoid garment soiling due to incontinence events and also provides improved access for hygiene, nursing, and medical procedures. This increased separation is a direct result of the converse nature of the recess 10 in this area and this feature can be applied to the use of the thigh garment 2 on only one specific limb (e.g. left or right) such that a particular garment is specifically intended for use only on one limb or, alternatively, the converse recess 10 can be large enough such that the separation is always applied and hence the garment 2 can be applied on either thigh of the patient.

With reference to FIG. 4, in one aspect, the garment 2 includes a single inflatable chamber 14 for applying compression to the patient's thigh 4. In one aspect, the inflatable chamber 14 is made of two layers of flexible material, such as polyvinyl chloride (PVC), polyurethane (PU), or polyolefin (PO) formed together to form at least one chamber, for example, through the use of a radio frequency, heat, or ultrasonic welding process. In one aspect, the inflatable chamber 14 is positioned in the center of the garment 2 and extends between the proximal edge 12 and a distal edge 16 of the garment 2. The inflatable chamber 14 is configured to receive and release pressurized fluid, such as air, so as to apply a compression force to the patient's thigh 4. The inflatable chamber 14 is positioned within the garment 2 such that at least part of the inflatable chamber 14 is aligned with the target compressible area on the patient's thigh when the garment 2 is mounted on the patient leg. In one aspect, pressurized fluid is directed to the inflatable chamber 14 from a pump 18. The pressurized fluid is directed into the inflatable chamber 14 via an inlet tube 20. The inlet tube 20 may be welded between the two layers of PVC, PO, or PU of the inflatable chamber 14 to form a connection from pump 18 to chamber 14 or, alternatively, the inlet tube 20 can be attached by means of an intermediate connection, such as a grommet or other form of pneumatic connection. When the garment 2 is positioned on the patient's thigh 4, the inflatable chamber 14 is configured to provide compression on an inner surface of the patient's thigh 4. To release pressure on the patient's thigh 4 and remove air from the inflatable chamber 14, the air in the garment 2 may be returned to the pump 18 through the inlet tube 20. It is also contemplated that secondary air paths (not shown) to atmosphere in the form of small vent holes in the inflatable chamber 14 or a small vent tube to atmosphere to release the air from the inflatable chamber 14. A valve within the pump 18 connects the inflatable chamber 14 to the source of pressurized air or to atmosphere to vent the air.

The garment 2 provides compression to the main muscle mass of the thigh 4 in the anatomic region formed by the main muscle groups of the thigh 4, including the rectus femoris, pectineus and upper adductor longis muscles. The compression of the muscular tissue in this area of the thigh 4 then provides compression of the outer veins, such as the femoral vein and the great saphenous vein, together with the veins located more internally, such as the deep femoral vein and the perforating vein. It is the combination of the compression of the outer and inner veins that ensures the improvement in the effectiveness of the garment 2 in moving venous blood and also providing the garment's 2 increased tolerance to rotational position on the thigh 4. The anatomical region is also associated with arteries, such as the femoral artery and these are also associated with aspects of the compressive effects of the thigh garment. When the thigh 4 is compressed alone without compression more distally in the limb), blood is moved from the veins in the thigh region in a proximal manner and, hence, out of the leg. This results in a first hemodynamic effect in terms of the volume of venous blood moved and the increase in blood velocity that can be measured in the veins, which is larger in magnitude than that achieved in the equivalent compression of the calf. Upon the deflation of the thigh garment 2, a second hemodynamic effect occurs, the resulting reduction in venous pressure within the thigh veins results in an increased pressure gradient between the distal calf/foot and the proximal thigh 4, which further increases flow from the lower leg area, such as the calf veins, and this causes blood to move proximally into the thigh 4. Thus, the compression of the thigh-only results in increases in flow in the lower leg where there is no direct compression applied as well as the compressed thigh area. The present invention, therefore, specifically includes the method and steps involved in the compression of only the patient's thigh to prevent MIT from forming in the lower parts of the limb.

The veins within the thigh 4 are larger in diameter than those found lower in the leg (e.g. in the calf). As a result, there is a larger volume of blood present in the thigh veins than the calf veins. Therefore, when a compressive force is applied to the thigh area, a larger volume of blood is moved. Further, the anatomy of the thigh 4 is such that the veins in this region are more circumferentially distributed and also more centrally located within the thigh than the veins in the calf. Thus, the use of compression only on the thigh 4 ensures that the compression is more effective, easier to achieve, and reliably applied in a region that includes veins that are more widely distributed than other anatomical regions, as a result this results in an increase in the compression effectiveness. It is these two distinct compressive effects that stem from a single inflation event that increases the overall blood flow and thus prevents venous stasis. The thigh region also typically has more compressible tissue than the calf region. Therefore, the use of a thigh-only garment 2 has particular benefits in patients where calf compression is less effective, such as patients with low body weights, reduced calf muscle mass, the elderly, or where a lower level of inflation pressure is preferred or required. A specific method of applying compression to only the patient's thigh 4 using the garment 2 is described in more detail below.

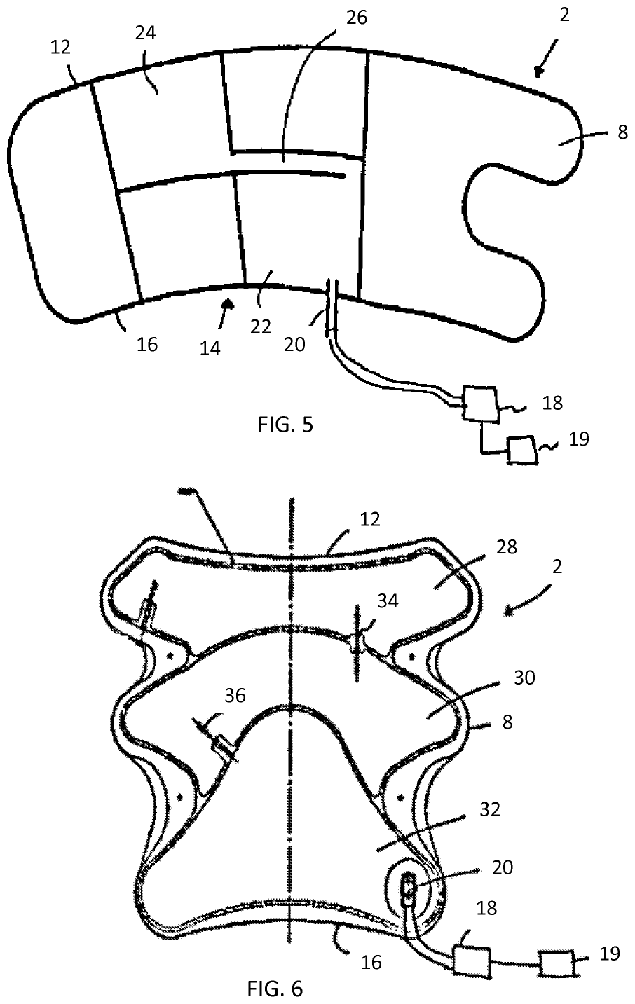

With reference to FIG. 5, in another aspect, the garment 2 includes a single inflatable chamber 14 with offset sections 22, 24 that provide compression in differing circumferential regions, including in one aspect, a predominantly anterior location. The compression in another aspect can be targeted at the sides of the limbs, in terms of the chamber location on areas such as on an inner surface and an outer surface of the patient's thigh 4. It should be clear to those skilled in the art that the compression effect, whilst emanating from the positon of the inflatable chamber, is also circumferential in nature as the tightness of the garment results in an applied circumferential force to the limb. The inflatable chamber 14 includes the two offset sections 22, 24 separated by a channel 26. Pressurized fluid is supplied to the inflatable chamber 14 via a pump 18 that directs the pressurized fluid into an inlet tube 20. During operation of the garment 2, the pressurized fluid is first directed into the first offset section 22, through the channel 26, and subsequently into the second offset section 24. As the first offset section 22 (located distally) is nearly fully filled with pressurized fluid, the second offset section 24 (located proximally) will begin to fill with pressurized fluid. This results in a sequential effect (from distal to proximal) where the offset section located distally compresses part of the thigh 4 before the offset section located more proximally and results in a pressure gradient in the garment 2 that promotes the flow of fluid in a proximal direction. When positioned on the patient's thigh 4, compression is applied to an inner side surface and an outer side surface of the patient's thigh 4 since one offset section 22, 24 is positioned on the inner side surface of the patient's thigh 4 and the other offset section 22, 24 is positioned on the outer side surface of the patient's thigh 4.

With reference to FIG. 6, in another aspect, the garment 2 includes three separate inflatable chambers 32, 30, 28 that extend across the entire distal-proximal length of the garment 2. A similar configured garment, intended for other areas of application, is disclosed in International Patent Application Publication No. WO 2014/068288, which is herein incorporated by reference in its entirety. Pressurized fluid is supplied to the inflatable chambers 32, 30, 28 via a pump 18 that supplies pressurized fluid to the first inflatable chamber 32 through an inlet tube 20. The pressurized fluid is directed into the first inflatable chamber 32, through a transfer tube 36, into the second inflatable chamber 30, through another transfer tube 34, and into the third inflatable chamber 28. The transfer tube 36 establishes fluid communication between the first inflatable chamber 32 and the second inflatable chamber 30. The transfer tube 34 establishes fluid communication between the second inflatable chamber 30 and the third inflatable chamber 28. As the first inflatable chamber 32 is nearly filled with pressurized fluid, the second inflatable chamber 30 then begins to hold pressurized fluid. Likewise, as the second inflatable chamber 30 is nearly filled with pressurized fluid, the third inflatable chamber 28 begins to hold pressurized fluid. This type of compression of this aspect of the garment 2 is referred to as sequential compression. It is also contemplated that an alternative construction involving separate inlet paths can be provided to each inflatable chamber 32, 30, 28 so that the pump 18 can supply pressurized fluid to each inflatable chamber 28, 30, 32 in a similar manner as described above or at the same time but via individual separate paths from the pump 18. The sequential compression creates a pressure gradient along the inner side surface of the patient's thigh 4. In one aspect, the three inflatable chambers 32, 30, 28 do not have a single pressure when pressurized, there being a difference in the chamber pressures during at least part of the cycle. In another aspect, the three chambers 32, 30, 28 all have the same pressure applied. In another aspect, the three chambers 32, 30, 28 all have the same pressure applied. In another aspect, the pressures are applied at differing times to the chambers 32, 30, 28 to provide a different type of sequential compression effect. In another aspect, different pressures can be applied at differing times to provide a sequential compression effect solely within the chambers of a thigh-only garment. In another aspect, there is only one chamber, in another aspect the chamber has two distinctly separated parts but is intended to have the same pressure in both. In another aspect the chambers are located within a thigh garment (as detailed in FIG. 4, FIG. 5, and FIG. 6) and such that they locate on the anterior region of the thigh. As detailed in FIG. 6, one embodiment involves a thigh-only located garment with multiple chambers, either connected together within the garment, or alternatively connected externally to the garment. In a yet further aspect, the chamber shape and position within the thigh garment are arranged such that the garment is suitable for use on either thigh of a patient, hence the thigh garments are bilateral in application to the patient, The bilateral design of the thigh garment described above allows for it to be provide to healthcare users in either the form of a singular package (convenient for amputee or orthopedic patients) without concern for specifying the applicable limb (e.g. left or right leg). Alternatively, it can be provided in a multiple package with at least two thigh garments, these can be applied to either limb hence simplifying both nursing and patient use of the thigh garment. In a yet further aspect, the thigh-only garment is specifically designed for optimal performance on a given limb (e.g. left or right) and is therefore marked with the indicated limb accordingly. The marking can be in the form of a screen-printed indication on the garment to allow the user to identify which particular garment is intended for which particular limb.

Due to the anatomical dimensions of the patient's thigh 4, the garment 2 and specifically the inflatable chamber(s) 14 (32, 30, 28) are shorter than that found in calf garments. The garment 2 also encompasses a wider circumference as the thigh 4 is typically significantly wider than the calf on a patient. In one aspect, the thigh garment 2 is located in the middle region of the thigh 4 and is small enough to be physically clear of the patella distally and the genitalia proximally. This ensures that the garment 2 is able to be used in a clinically effective manner without nursing complications during a wide range of procedures and care activities. In order to fit within this region, the height of the garment 2 (measured from proximal or distal) is less than 200 mm. The dimensions of the inflatable chamber(s) 14 (32, 30, 28) are such that the inflatable area extends around the thigh 4 to ensure that the compressive force is applied directly into the tissue mass over an area that exceeds 25% of the median circumference of the limb.

In one aspect, the at least one inflatable chamber 14 has a ratio of its maximum width dimension relative to its minimum width (dimension) of at least 1:0.75. Therefore, the inflatable chamber 14 is wider at its proximal width than it is at its distal width. The garment 2 is shaped to adjustably fit to the thigh 4 such that the garment 2, when wrapped around the thigh 4, has a smaller distal circumference than a proximal circumference. In a further aspect, the length of the garment measured from proximal to distal is less than 200 mm, in another aspect, the ratio of the inflatable chamber(s) width (as measured around the thigh circumference) to its height (as measured proximal to distal) is greater than 1.6:1 and less than 3:1. Due to the nature of the anatomical position of a thigh-only garment and its potential (under a potential failure mode) to act as a form of tourniquet, there are further aspects that are specifically within the scope of the invention that relate to ensuring chamber deflation. The preferred deflation path for the at least one chamber in the garment is back into the pump following an outlet path that is the same as the inlet fluid path. In a further aspect, the thigh garment includes an additional vent mechanism, in the form of a fluid path directly to atmosphere to ensure deflation in the event of any potentially introduced restriction in the fluid path back to the pump, for example as shown with an additional choke tube located in chamber 28 in FIG. 6 to allow an outlet of the air fed in by the inlet choke tube 34. This additional deflation mechanism can also be in the form of dedicated vent paths from each or at least one of the chambers through choke tubes with a controlled internal diameter to allow for known fluid flow to atmosphere. An alternative aspect involves the use of specially introduced small ‘micro holes’ placed in at least one chamber (32, 30, 28) or in the integral connecting tube attached at the grommet 20. As well as providing an additional vent path, in normal operation the air from these micro holes can be used to provide additional benefits such as ventilation to the thigh of the patient. This also contributes to overall garment and patient comfort by improving the microclimate (temperature and moisture) around the patient's thigh and in the thigh garment material. This occurs as a result of the positive air flow from these specific vent paths in/from the chamber(s) and as a result reduces heat and moisture build-up and also dissipates moisture (from sweat and potentially urine) as well as promoting the flow of heat away from the thigh region and the patient.

One advantage of the garment 2 as compared to existing MIT garments and compression hosiery is that the garment 2 is physically fitted to and used solely on a patient's thigh 4, and so can be used in cases where the access to or the use of a calf or foot garment is not possible. There are many clinical situations where it is not possible to locate a garment on the patient's calf or foot and, therefore, a thigh-only garment 2 is desired. The garment 2 offers several advantages over conventional calf garments or foot-based garments in the following clinical application areas: orthopedic situations including the use of casts/fixators on the calf; patients with cellulitis in the calf; to avoid complications with compressing sensitive tissue areas around calf, ankle or heel area; diabetic patients where compression of the foot may be painful; amputees (both below and above the knee) where there is no calf or foot to compress; knee surgery (as conventional calf garments may be too close to the surgical site); ankle/foot surgery (as conventional foot and calf garments are too close to the surgical site); patients requiring DVT prophylaxis but with an outsize foot or calf (e.g. due to conditions such as elephantiasis, edema, lymphedema, etc.); patients undergoing surgery that requires specific venous access to the lower limb (e.g. venous stripping or varicose vein procedures); patients undergoing treatments that require access to the lower limb; patients with existing lower limb problems where compression of the calf may be contraindicated, the thigh could be used as an alternative for bariatric patients instead of calf garments; in procedures requiring complicated lithotomy positions/patients with limb elevation (this covers many procedures in a diverse range of surgical areas such as general surgery, urology, gynecology); patients with leg ulcers, wounds, burns or skin conditions on the calf or foot; additional specialist conditions where an increase in blood flow is required; patients who are not compliant with the continued use of foot or calf based garments; and heavier patients where the weight of their limb can affect the inflation of calf based garments.

The garment 2 also provides several additional advantages over conventional calf/foot garments. For example, there are particular patient types (e.g. elderly or low weight patients) where it is more effective in terms of achieving the blood flow by compressing the thigh than other anatomical areas. These patients may not be able to or may not want to use a compression device on their calf and/or foot. The garment 2 also provides improved effectiveness and flexibility of the location of the positioning of the inflatable chamber 14 in relation to the patient's thigh 4 compared to using calf garments. The garment 2 is also much more tolerant to variation in the positioning and re-positioning of the garment 2 by the patient and nursing staff in terms of the circumferential position of the inflatable chamber(s) compared to calf garments. Therefore, a higher level of effectiveness in the delivered compression is able to be provided by the garment 2 in actual clinical use.

The garment 2 also moves a larger volume of blood as compared to a calf/foot garment. As a result, the garment 2 is both more effective in achieving its aim of preventing venous stasis and also more tolerant to the variations found in limb mass and size, fitting of the garment to the limb, positioning on the limb, patient position, and inclination and the actual clinical use in a wider range of patients. The increase in blood moved in both volume and velocity terms (compared to a calf compression) also provides an increase in the beneficial effects through increases in the turbulent nature of the blood flow, thus further helping in preventing thrombus development. Further, since the thigh garment 2 does not locate the inflatable chamber(s) directly underneath the patient's limb (as is the case with the prior art), it is easier to inflate the garment 2. Therefore, the pneumatic requirements are reduced for the garment 2, which results in less electrical power consumption and an improvement in battery duration of a pump when using the garment 2.

The garment 2 also includes a reduced garment size and, therefore, a reduced amount of garment material on the patient's limb, which reduces the thermal effect on the patient as compared to that of a combined thigh and calf garment. By reducing the amount of material needed to be in contact with the patient anatomy, the thigh garment 2 is more comfortable and improves patient compliance. The reduced garment size also allows for a more cost effective garment to be produced and offered to health care providers. The garment 2 also provides an ease of connection and disconnection of the garment 2 from its pump connections as compared to a calf garment. Many patients have difficult in physically reaching down to their lower calf in order to disconnect the connection (e.g. when wishing to move from the hospital bed to the bathroom). It is easier to access the thigh garment connectors as the connectors are closer to a patient's hands. This aspect has significant benefits in reducing the need for nursing assistance, reducing the risk of falls due to tripping, aiding easier and earlier mobility, reducing the sense of being constrained by the system, and ensuring the system is reconnected and actually used upon the patient's return to bed.

The thigh-only garment 2 of the present disclosure also includes significant functional differences from a prior-art calf garment that could conceivably be repositioned up the leg onto the thigh 4 of the patient. In one difference, the position of the inflatable chamber 14 relative to the required target compression area is not equivalent. A calf garment that is moved up the patient's leg would result in the inflatable chamber being positioned behind the patient's thigh. The thigh-only garment 2 of the present disclosure positions the inflatable chamber 14 on the inner surface of the patient's thigh 4. In another difference, the length of a calf garment is longer than a length of a garment that would actually fit above the patient's knee on the patient's thigh 4.

In one aspect, the thigh-only garment 2 of the present disclosure is designed for the duration of a single-patient's use only. In a further aspect, the single-patient use garment 2 may also be capable of extended use and required to be cleaned, sanitized, or sterilized between the clinical uses by multiple patients. The thigh-only garment 2 can also be constructed such that it can be capable of being subjected to an approved cleaning process such that it may be subsequently cleaned, sanitized, or sterilized after a previous use by a patient. In another aspect, the thigh-only garment 2 is specifically designed for multi-patient use and, therefore, requires ease of cleaning within a hospital environment. The garment 2 can be cleaned using a variety of processes, including disinfection using ethylene oxide gas after a patient's clinical use of the garment 2. The garment 2 can also be processed using, for example, ethylene oxide gas or gamma sterilization before a patient clinical use of the garment 2 in order to provide an initial cleaning or sterilization step. The garment 2 construction can be such that it is optimized such that it can be cleaned using high level disinfection (HLD) processes. The methods and processes involved in cleaning of the thigh-only garment 2 lie also within the scope of the present invention.

### II. Double Pulsation Compression Method

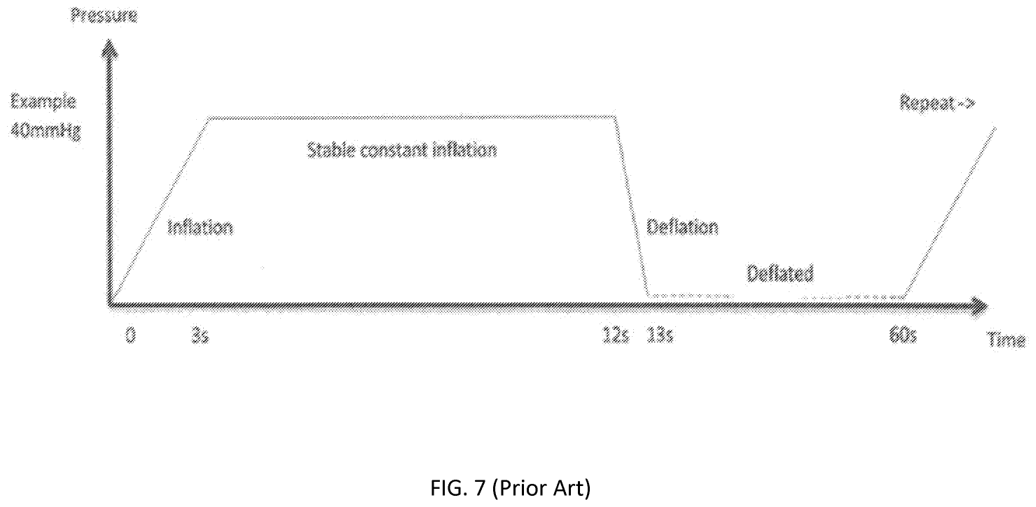

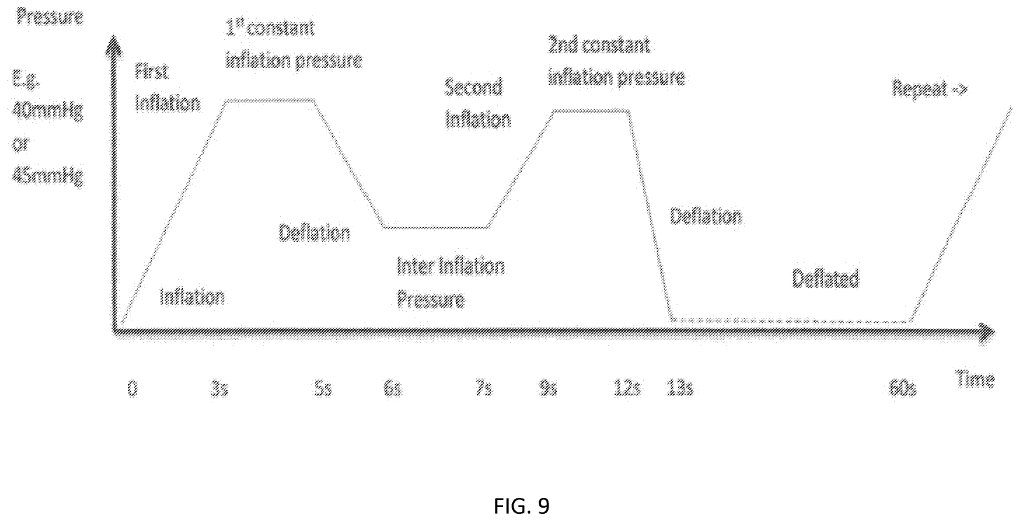

With reference to FIG. 7, a method of compression used with the thigh garment 2 is shown and described. This method of compression includes applying pressure to a patient's limb so that the pressure and time characteristics of the applied pressure waveform result in an improved form of prophylaxis. In another aspect, the method of compression shown in FIG. 9 is used with the thigh-only garment 2 described above. While the method of compression is described in relation to the thigh-only garment 2 described above, it is also contemplated that this method of compression can be used with any garment applied to any part of a limb of a patient, including those used on a foot, calf, thigh/calf, thigh, or arm. It is a further aspect of the disclosure that the pump 18 connected to the garment 2 is able to provide this mode of operation either at the selection of the user or automatically based on the specific detection of the automatically sensed specific garment 2. The method of compression is performed in a repeating manner using a pump 18 and an associated garment 2 that is fitted to a patient's limb, for example, the thigh 4. The pump 18 provides the compression medium (usually pressurized air) in an intermittent manner to the garment 2. The pump 18 controls the timing of the applied pressure by means of a defined pressure waveform. The method includes compressing the patient's limb using an inflatable garment 2 with a modified compression waveform that includes two time-linked compression aspects providing a double pulse of compression to the patient's limb, instead of the traditional single compression pulse. The combination of two distinct compressions within a short period (for example, less than 10 seconds) with an intervening reduced level of compression provides for a greater movement of fluid (e.g. blood) to be moved in terms of volume and its velocity within the patient's limb and, therefore, provide a more effective prevention of venous stasis.

The method involves a first compression intentionally designed to provide the same level of effective prophylaxis as typically found in conventional garments, an intervening aspect involving a pressure and time followed by a second additional compression that augments the prophylaxis by providing two further beneficial effects. The second compression causes a further movement of the venous blood resulting in an increase in the total quantity of blood moved within the vessels of the patient's limb. The reduction in pressure between the first and second compression allows the vessels in the limb to start to refill using the body's normal process distally to proximally. This additional fluid is then moved during the second compression. The second compression also provides a further compression of the vessel walls and augments the release of the naturally-generated anti-coagulant substances from the vein walls into the venous blood.

As shown in FIG. 9, the method of compression of the present disclosure includes a different pressure waveform between the inflation stage and the deflation stage compared to that shown in FIG. 7. The first portion of the pressure waveform is an inflation stage for the garment in which the pressure in the inflatable chamber(s) 14 of the garment 2 is stabilized at a first constant pressure level. In one aspect, this inflation stage may last for 4 seconds. After the inflation stage, the pressure waveform has a deflation to a lower second pressure value (an inter-inflation pressure) and this is maintained for a time before the second rise of pressure occurs to a second constant inflation pressure or third pressure level. The second pressure value may be lower than the first pressure level. The second pressure value may be lower than the third pressure level. The first and third constant inflation pressure levels may be the same level or may differ. It is within the scope of the disclosure that either the first or second constant inflation pressure levels can be larger than the other.

In one aspect of the disclosure, the inflation of the inflatable chamber(s) 14 to the first constant pressure level lasts for a duration of at least one second. The inflation of the inflatable chamber(s) 14 to the first constant pressure level lasts for a duration of at least two seconds. The second pressure value may be maintained for a duration of at least one second. The first pressure level and the third pressure level may be greater than 25 mmHg. The first pressure level and the third pressure level may be at least 40 mmHg. The first pressure level and the third pressure level may be at least 45 mmHg. The second pressure level may be greater than zero mmHg and less than 30 mmHg. The second pressure level may be greater than zero mmHg and less than 20 mmHg. The deflation of the inflatable chamber(s) 14 from the first pressure level to the second pressure level may last for a duration of at least two seconds. The entire pressure cycle of the garment 2 may be less than 15 seconds. The entire pressure cycle of the garment 2 may be 12 seconds. The pressure cycle of the garment 2 may be repeatable and may be followed by an extended period of deflation lasting greater than 28 seconds. In another aspect, the extended period of deflation may last up to 48 seconds.

The duration of the first ramp of pressure to the first pressure level may be equivalent to the duration of the second ramp of pressure to the third pressure level. The duration of the first ramp of pressure to the first pressure level may be greater than the duration of the second ramp of pressure to the third pressure level. The average rate of pressure increase during the garment inflation cycle is greater than +10 mmHg per second. The third pressure level may be a fixed proportion of the first pressure level. The first pressure level and the third pressure level may be within 5 mmHg of one another. The first pressure level may be greater than the third pressure level. In one aspect, the third pressure level may be greater than the first pressure level.

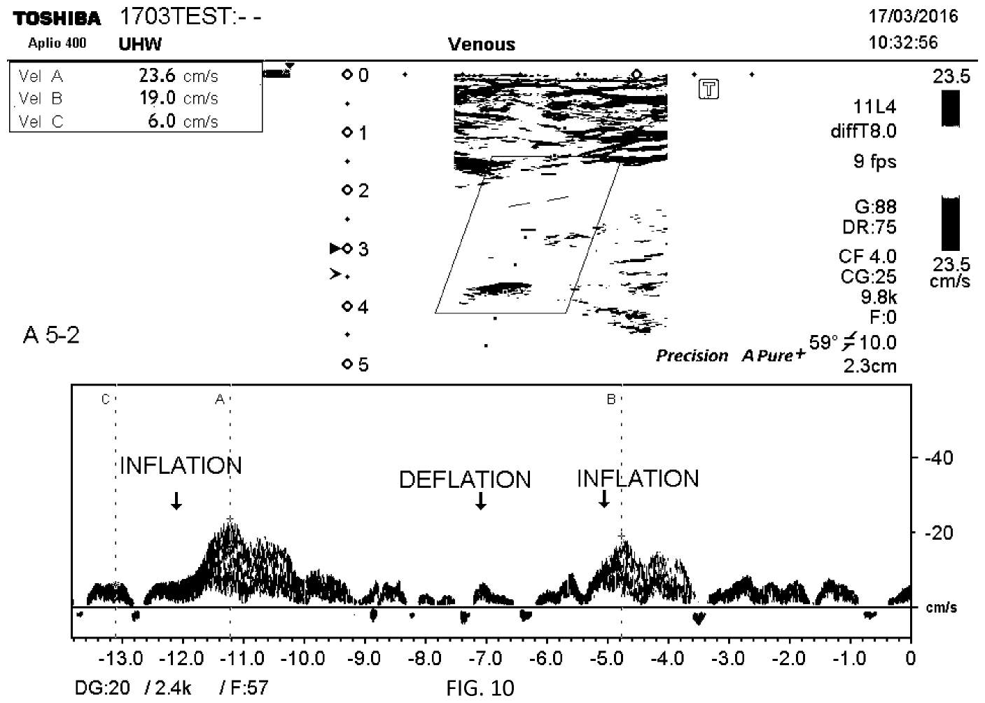

FIG. 10 illustrates an ultrasound scan image of the compression method and pressure waveform according to the present disclosure. The scan image shows the effect of the compression method of the present disclosure on the femoral blood velocity (y axis) against time (x axis) over a 13 second scan period. The scan image shows two separate pulses of blood velocity that directly align with and relate to the distinct inflation stages of the compression pressure waveform. The baseline femoral venous velocity before the compression is shown as Marker C (Vel C=6.0 cm/s), this represents the resting baseline velocity of the patient. The initial inflation of the garment on the limb lasts from −13 second marker to the −10 second marker. This inflation creates a first increase in the blood velocity (to a peak of Vel A=23.6 cm/s) that is significantly higher than the baseline velocity. The pressure waveform then results in a partial deflation of the garment occurring from the −8 to the −6 second marker that is associated with the lower Inter Inflation Pressure section of the pressure waveform. This pressure corresponds with a reduction in the femoral velocity as the majority of blood in the veins in the limb has already been moved by the previous compression. The second inflation then occurs from −6 second marker to 0 second marker and this results in a further blood velocity of Vel B=19 cm/s. This second inflation pulse results in a second increase in the femoral velocity that is not found with the operation of ‘single pulse’ prior art systems.

In one aspect, the velocity of the second fluid inflation is to be typically less than that achieved by the first fluid inflation, since the vessel is fully charged prior to the first compression. Therefore, the compression force applied by the garment 2 is applied on the full contents of the vessel and tissue covered by the garment. Once this first compression is completed, the lower pressure present between pulses allows the vessel/tissue to refill using natural circulation processes. This refill takes many seconds, so this means that there will only be a partial amount of fluid available for the second compression compared to that available for the first compression. The resulting second compressive force, therefore, acts on less fluid than the first compressive force and, as such, it results in less velocity augmentation. However, since the second pulse is in addition to the first pulse, any additional increase in blood moved or increase in velocity achieved is in addition to that of the first pulse and provides for a more effective compression method.

The second impulse provides a significant increase over the baseline blood velocity and hence ensures that even more fluid is expelled from the limb. In addition, the second impulse provides a secondary impulse within the blood and into the vessel (e.g. vein) and results in a repeat of the fluid movement operation associated with the first impulse. The relationship and value of the rise of applied pressure over time (dP/dt) between that of the first pulse (dP1/dt1) and that of the second pulse of pressure (dP2/dt) provides a method for maximizing and balancing the blood moved by the two impulses. In one preferred aspect, the dP1/dt1 value is unchanged from the prior art and has an average value in excess of 5 mmHg/s and preferably greater than 10 mmHg/s. The second rise of pressure dP2/dt2 is typically either similar or less than the first dP1/dt1. In yet another alternative embodiment, the second rate of rise dP2/dt1 is faster than that of the first rate of rise DP1/dt1. It is a further aspect of the disclosure that the increased velocity augmentation achieved in the second impulse is at least 50% of the increase in velocity augmentation achieved by the first impulse. This dual impulse function provides a particular benefit in ensuring there is a lower pressure period between the first and second impulses. This aids the overall effectiveness and comfort of the applied therapy and reduces the average pressure applied to the limb.

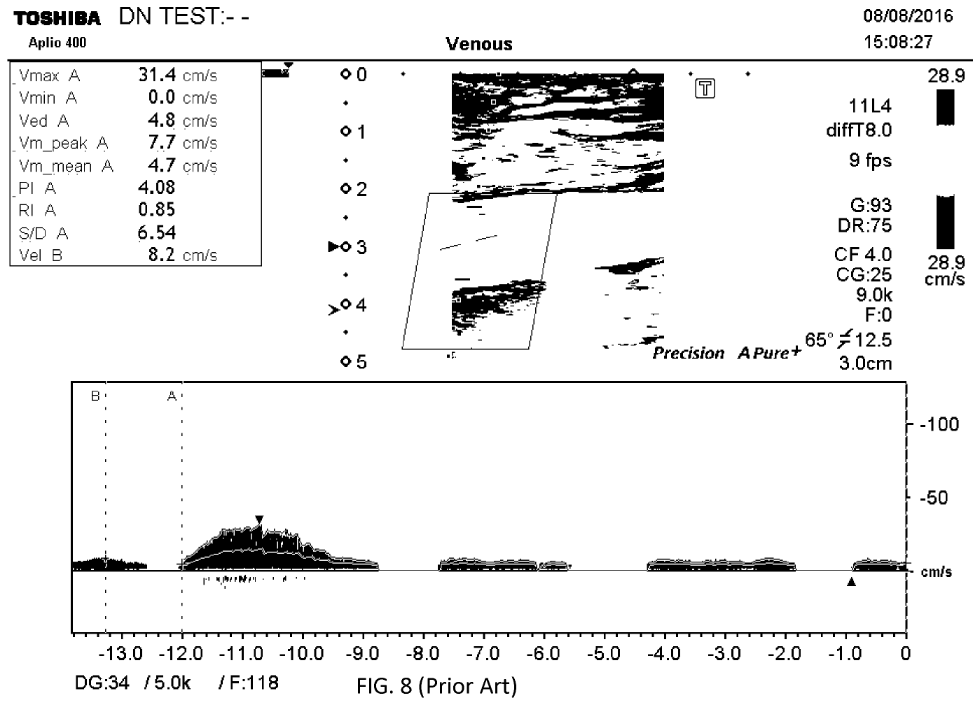

The increase in the total amount of blood moved as a result of the present compression method is directly related to the sum of that achieved by the two impulses. This total amount of blood is equal to the area under the velocity curve during the 12 second period of the pressure waveform in FIG. 10. This is significantly more in the case of the pressure waveform of the present invention than the pressure waveform of the prior art shown in FIG. 8. In fluid flow terms within a vessel, the first impulse acts upon the fully charged vessel and moves the fluid located within it in a proximal direction. The resulting lower pressure in the vessel then allows a recharge of pressure from the distal region of the patient's limb and this fluid is then compressed by the second impulse. Therefore, the intermediate pressure between the two compression pulses of the present compression method is sufficiently low such that fluid located distally to the garment can flow into the vessels located in the area beneath the garment 2. The second compression then acts upon this fluid located in the vessels. The pressure applied between the two compression pulses is less than the pressure necessary to achieve venous closure pressure on the limb where the garment is located. In one aspect, the pressure necessary in the calf and thigh region is typically less than 30 mmHg.

There is no change required to the timing provided between applications of pressure on the same limb as compared to the prior art methods and the present compression method. Therefore, the time relationship between the compressions and the natural venous refill of the patient's veins is maintained. Thus, the present compression method can continue to operate with the proven benefit of utilizing the same 48 second rest period between applications as found in the prior art method. Further, the present compression method does not require a change in the overall time during which pressure is applied to the patient. Thus, the two inflations occur within the current 12 second inflation period found in the prior art method.

Any increases in the venous flow through the patient's limb are also known to have a beneficial secondary effect associated in the form of an associated increase in the patient's arterial flow. Therefore, the two-part compression pulse of the present disclosure is also applicable to increase arterial flow in a patient's limb. Further to this advantage, there are ancillary benefits in terms of the augmentation of lymphatic fluid flow within the limb. The total amount of blood moved out of the limb over time (i.e., the volumetric flow rate) achieved by the present invention's compression waveform results from the integration of the blood flow velocity over time, this amount can be visibly represented by considering the area under the fluid blood velocity curve of the Doppler velocity waveform shown in FIG. 10. It can be seen that there is a significant secondary flow of blood that is achieved by the secondary compression that is significant and clinically beneficial to the patient.

In the case of VTE prevention, the present compression method seeks to overcome an inherent limitation of compression systems. The maximum amount of blood that can be acted upon by a single compression is inherently limited to the blood located in the veins under the compression garment and also the blood located in the veins proximal to compression site. Once this blood has been moved then the prior art systems are not able to move any more blood until the veins have been recharged with venous blood though the normal circulatory process. In particular, the prior art systems cannot move any blood located distally to the compression site during the compression and this blood is not moved until the time of the compression when the blood moves more proximally in the patient's limb as a result of the body's natural circulatory processes. The effectiveness of a compression of the limb in moving venous blood out of the limb is inherently limited due to the need to act against and move the entire column of blood proximal to the compression site. This is even more difficult in the case when the patient is not lying in a supine position but is instead positioned in a sitting or angled position, such as some of the well-known clinical patient positions that are used during surgical procedures and during prolonged periods of patient care.

Since the present invention details compression method that utilizes a period of lower pressure after the initial inflation, this allows the blood located distally to the compression site to move proximally into the compression site due to internal venous pressures in the time before the second inflation. This second inflation then provides a second impulse to the blood in the venous system. The present invention is, therefore, even more capable in terms of moving blood and overcoming venous stasis as it employs two compression impulses and, therefore, imparts two impulses to the column of venous blood. As a result of these impulses, there is an increased total amount of blood moved through and from the patient's limb. This increase in total blood flow moved through the patient's limbs can be beneficial in patients that have a lower hemodynamic flow level or who have increased level of edema due to the buildup of interstitial fluid in the tissue.

In one aspect, a control system 19 is used to control the pump 18 to provide pressurized fluid to the garment 2. The control system 19 utilizes the measurement of the pressure in real time as delivered to the garment 2 using a pressure transducer in the pump (not shown). This measurement of the pressure allows for precise and repeatable delivery of the pressure waveform to the garment 2. This pressure measurement forms an input to the control algorithm used to control the output of the pump 18 to provide the pressurized fluid to the garment 2.

The reduction in pressure from the first inflation to the lower inter-inflation pressure is controlled to ensure that the required pressure level is achieved. This can be achieved by use of the control system 19 providing a controlled modulation of the pump 18 energy as an input variable, including a reduction in the applied power, such that less pressurized fluid is applied to the inflatable garment 2. Additionally, or alternatively, the pneumatic control system can employ a specific vent path to atmosphere to reduce the pressure, such as through a vent path in a pump distribution valve or through garment-located vent holes and paths.

The control of the garment pressure though the various parts of the pressure waveform can be readily achieved through the use of a number of well-established mathematical-based control techniques well known to the prior art. Examples of these control techniques include the use of closed loop control using differing control approaches, such as Proportional Integral Derivative (PID), ‘bang-bang’ on-off, and fuzzy logic control methods. A closed loop control system can also be utilized that manages the applied power to the pump 18 and uses pneumatic balancing of the resulting applied pressure against controlled leaks in the system to achieve the necessary pressure at any point in the pressure waveform. These techniques can be used either in a single manner for the entire pressure waveform or, alternatively, multiple techniques can be used with the individual selection of a single control technique for each of the differing aspects of the pressure waveform. The control of the output of the pump 18 is achieved using the control capabilities of the control algorithm to set the input requirement for individual control of the pump response using, for example, the Pulse Width Modulation (PWM) approach disclosed in U.S. Pat. No. 7,038,419, which is hereby incorporated by reference in its entirety, and the resulting pressure compared against a time-varying target pressure in the garment 2.

It is a further aspect of the disclosure that the connected garment type is automatically identified by the pump 18 and, as a result of this garment identification, the appropriate control algorithms and parameters are applied to the pressure waveform for the garment. This approach allows the pump to optimize the control of the pressure waveform based on the specific garment type connected. The thigh garment 2 includes an identification or sensible component located at the connector present between the connecting tube 20 and the control unit 8 and that can be sensed by the control unit to allow the thigh garment 2 to be detected and differentiated from other and different garment types and sizes.

The compression method described in the present disclosure provides several advantages over single-impulse compression methods used in the prior art. Quantitative analysis of the timing and inflation requirements of the garment 2 indicate that there is sufficient time within the 12 second inflation period common in the prior art to achieve the multiple impulses of the present disclosure. For example, utilizing the same rate of inflation rate (i.e. +dP/dt) for each of the two inflation stages as the prior art ensures that the same resulting velocity of the blood moved is achieved and its turbulent nature is maintained. In one aspect, the rate of increase in pressure during inflation is greater than 10 mmHg per second.

Intermittent compression systems of the prior art that use a single compression maintain a constant force onto the tissue of the limb for a prolonged period. The present compression method reduces the average force applied to the limb compared to the prior art methods. Reduction in the total amount of pressure applied to the limb over the same 12 second period compared to the compression waveforms in the prior art also provides benefits to the skin and tissue of the patient. Ensuring that the comfort of the prophylaxis is improved is important to promote patient use and compliance with the physician's prescribed therapy. Therefore, it is a benefit of the present compression method that the patient's comfort is improved since the pressure level is not applied for as long within the 12 second inflation as is the case with the prior art.

Further, relying on the effect of just a single inflation only achieves a certain degree of blood fluid movement both in terms of volume and increase in velocity. The use of multiple similar inflations within the garment, however, results in greater amount of blood movement in the patient's limb. Limitations due to smaller capacity system components, such as air sources or battery based power sources, is less of an issue due to the reduced pressure requirements of the pressure waveform. The system does not need to maintain the garment pressure at such a high value for as long as it is maintained in the prior art methods.

In another aspect of the disclosure, the system providing the pressure waveform is capable of sensing or utilizing a clinical parameter from the patient and, as a result, varying the timing and pressure aspects of the applied pressure waveform detailed above. This results in variation in the prophylaxis over time and allows for further benefits to the patient, such as improved comfort and effectiveness. This clinical parameter may be a measurement from the patient, such as breathing rate or pulse or other parameter. This clinical parameter could be provided to the compression system so that the multi-impulse parameters can be adjusted based on the specific clinical condition of the patient. Alternatively, the compression system could monitor the delivered pressure duration and adjust the compression waveform based on the amount of delivered prophylaxis to date. A further aspect of the disclosure involves the compression pulse parameters and timing being adjusted based on the time of day or whether the patient is asleep or not. Examples of clinical parameters that can be measured include patient position (e.g., supine, sitting), the size of the patient's limb within the known size of the connected compression garment, the nature of the limb in terms of tissue type and the associated degree of mechanical deformation, and the compression achieved. Further examples of factors that can be used in terms of the parameter include more general aspects including the prior usage of the system (hours or percentage of a target usage), specific clinical classifications (known risk factors and risk scores, use of other prophylactic treatments and medications). The level of the blood flow increase achieved is related to the parameters shown in FIG. 9, hence, it is within the scope of the invention that these parameters can be adjusted automatically by the pump or by the clinical staff dependent on the clinical needs of the patient.

It is a further aspect of the disclosure that the system can vary the timing and pressure aspects of the pressure waveform shown in FIG. 9 based on a pre-defined sequence without any measurement. As a result, the pressure waveform can be repeatedly provided to the garment 2 with differing pressure waveform parameters during the course of a period of prophylaxis. Therefore, the compression system is able to adapt the pressure waveform and the timing of the two impulses based on a variety of inputs, including the connected garment type, the selected pressure level, a patient-measured parameter, time, elapsed therapy or alternatively, a patient-based parameter that is communicated to the compression system.

The present compression method can be applied to existing designs of garments without requiring modification. The necessary control of the pressure waveform is provided by the pump 18. This is typically achieved by means of using a software and electronic-based control system to modulate the generation and application of pressure using a pump 18 and a pressure valve. The present compression method does not necessarily require any different control system or hardware, but merely involves a change to the software that controls the pressure level and timing.

While several aspects of the garment and double pulsation compression method are shown in the accompanying figures and described in detail hereinabove, other aspects will be apparent to, and readily made by, those skilled in the art without departing from the scope and spirit of the disclosure. Accordingly, the foregoing description is intended to be illustrative rather than restrictive. The invention described hereinabove is defined by the appended claims and all changes to the invention that fall within the meaning and range of equivalency of the claims are to be embraced within their scope.

1. A device for applying compression to a limb of a patient, the device comprising:
a sleeve configured to be positioned on the patient's limb, the sleeve comprising:
an internal sleeve passage configured to receive the patient's limb; and
at least one inflatable chamber; and
a control unit configured to supply pressurized fluid to the at least one inflatable chamber using the following inflation/deflation process:
inflating the at least one chamber from an initial pressure to a first pressure;
maintaining the at least one chamber at the first pressure for a first predetermined amount of time;
changing the pressure in the at least one chamber from the first pressure to a second pressure, wherein the second pressure is greater than the initial pressure;
maintaining the at least one chamber at the second pressure for a second predetermined amount of time;
changing the pressure in the at least one chamber from the second pressure to the first pressure or a third pressure greater than the second pressure;
maintaining the at least one chamber at the first pressure or third pressure for a third predetermined amount of time; and
deflating the at least one chamber to zero pressure or a fourth pressure.

2. The device as claimed in claim 1, wherein changing the pressure in the at least one chamber from the first pressure to the second pressure includes deflating the at least one chamber.

3. The device as claimed in claim 1, wherein changing the pressure in the at least one chamber from the second pressure to the first pressure or the third pressure includes inflating the at least one chamber.

4. The device as claimed in claim 1, wherein the second pressure is greater than zero and less than 45 mmHg.

5. The device as claimed in claim 1, wherein the second predetermined amount of time is at least two seconds.

6. The device as claimed in claim 1, wherein the inflation/deflation process is repeatable with a duration of time in-between each cycle of the inflation/deflation process lasts greater than 28 seconds.

7. A method of supplying pressurized fluid to at least one inflatable chamber of a compression garment, the method comprising:
inflating the at least one chamber from an initial pressure to a first pressure;
maintaining the at least one chamber at the first pressure for a first predetermined amount of time;
changing the pressure in the at least one chamber from the first pressure to a second pressure, wherein the second pressure is greater than the initial pressure;
maintaining the at least one chamber at the second pressure for a second predetermined amount of time;
changing the pressure in the at least one chamber from the second pressure to the first pressure or a third pressure greater than the second pressure;
maintaining the at least one chamber at the first pressure or the third pressure for a third predetermined amount of time; and
deflating the at least one chamber to zero pressure or a fourth pressure.

8. A compression garment wherein an entirety of the garment surrounds a thigh of a patient, the compression garment applying compression only to the thigh of the patient, the garment consisting of:
an outer sleeve configured to only be positioned on the patient's thigh; and
at least one inflatable chamber provided in the outer sleeve to apply a compressive force to the patient's thigh.

9. The garment as claimed in claim 8, wherein the garment further comprises a sensible identification component to allow the control unit to automatically identify a garment type as being of a specific type intended for the thigh.

10. A method of reprocessing the device claimed in claim 1, comprising the step of cleaning the device between subsequent uses by differing patients.

11. The method as claimed in claim 7, wherein changing the pressure in the at least one chamber from the first pressure to the second pressure includes deflating the at least one chamber.

12. The method as claimed in claim 7, wherein changing the pressure in the at least one chamber from the second pressure to the first pressure or the third pressure includes inflating the at least one chamber.

13. The method as claimed in claim 7, wherein the second pressure is greater than zero and less than 45 mmHg.

14. The method as claimed in claim 7, wherein the second predetermined amount of time is at least two seconds.
